(19) United States
(12) Patent Application Publication
(10) Pub. No.: US 2015/0109642 A1
(43) Pub. Date: Apr. 23, 2015

(54) IMAGE READING APPARATUS, METHOD FOR CONTROLLING IMAGE READING APPARATUS, AND STORAGE MEDIUM

(71) Applicant: CANON KABUSHIKI KAISHA, Tokyo (JP)

(72) Inventor: Hanae Gabe, Yokohama-shi (JP)

(21) Appl. No.: 14/515,384

(22) Filed: Oct. 15, 2014

(30) Foreign Application Priority Data
Oct. 21, 2013 (JP) 2013-218740

(51) Int. Cl. H04N 1/387

(52) U.S. Cl. CPC H04N 1/3877; H04N 2201/0094; H04N 2201/0081
USPC 358/448

(57) ABSTRACT

When images on a plurality of documents are read, to cause top and bottom directions of image data of the read documents to match one another, the image data of any document designated from among the documents cannot be rotated. To solve this problem, there is provided a control method in an image reading apparatus having a reading unit for reading images on a plurality of documents, to generate image data, includes selecting at least one of the plurality of documents, and performing rotation control so that the top of the image data of the selected document among the image data generated by the reading unit is directed toward a predetermined direction, wherein only some of the plurality of documents can be selected in the selecting.

### BACKGROUND OF THE INVENTION

1. Field of the Invention

The present invention relates to an image reading apparatus capable of reading an image on a document and appropriately rotating image data of the read document, and a method for controlling the image reading apparatus, and a storage medium.

2. Description of the Related Art

Conventionally, a technique for reading images on documents, performing character recognition processing (pattern matching) using an optical character reader (OCR) technique, for example, for image data of the read documents, and determining top and bottom directions (i.e., vertical direction) of the documents has been known. A technique has been discussed in Japanese Patent Application Laid-Open No. 2011-10033 for prompting a user to designate information about the top and bottom directions of the document corresponding to the first page if the top and bottom directions thereof cannot be determined, to rotate the image data of the documents.

However, in the technique discussed in Japanese Patent Application Laid-Open No. 2011-10033, the information about the top and bottom directions of the documents cannot be designated for any of the documents other than the document corresponding to the first page. Thus, if images on a plurality of documents, which are different in top and bottom directions, are read, it is impossible to rotate the image data of an arbitrary document designated from among the documents, in order to match the top and bottom directions of image data of the read documents to each other.

### SUMMARY OF THE INVENTION

According to an aspect of the present invention, an image reading apparatus includes a selection unit configured to select at least one of a plurality of documents, a reading unit configured to read images on the plurality of documents, to generate image data, and a rotation control unit configured to control rotation such that the top of the image data of the document selected by the selection unit among the image data generated by the reading unit faces a predetermined direction, in which the selection unit can select only some of the plurality of documents.

Further features of the present invention will become apparent from the following description of exemplary embodiments the attached drawings.

### BRIEF DESCRIPTION OF THE DRAWINGS

FIG. 1 is a block diagram illustrating a configuration of a printing system according to an exemplary embodiment of the present invention.

FIG. 2 is a cross-sectional view illustrating a configuration of an MFP according to an exemplary embodiment of the present invention.

FIGS. 3A and 3B illustrate a top and bottom direction of an image on a document and rotation of the image on the document in a multifunction peripheral (MFP) according to a first exemplary embodiment of the present invention.

FIGS. 4A and 4B illustrate a top and bottom direction of an image on a document set in a document feeding unit in the MFP according to the first exemplary embodiment.

FIG. 5 illustrates an example of a main screen for shifting to a screen for executing each type of functions in the MFP according to the first exemplary embodiment.

FIGS. 6A and 6B respectively illustrate examples of setting screens for setting mixed document size and document direction designation modes in the MFP according to the first exemplary embodiment.

FIG. 7 illustrates an example of a warning screen relating to mixed document sizes and document direction designation in the MFP according to the first exemplary embodiment.

FIG. 8 is a flowchart illustrating a series of processes for continuously reading images on a plurality of documents and transmitting image data of the read documents in the MFP according to the first exemplary embodiment.

FIG. 9 is a flowchart illustrating a series of processes for setting information about rotation of image data of a read document in the MFP according to the first exemplary embodiment.

FIG. 10 illustrates an example of a setting screen relating to rotation of image data of a read document in the MFP according to the first exemplary embodiment.

FIG. 11 illustrates an example of information about rotation of image data registered in a setting table in the MFP according to the first exemplary embodiment.

FIGS. 12A and 12B respectively illustrate examples of a result of rotating image data according to information registered in the setting table in the MFP according to the first exemplary embodiment.

FIG. 13 illustrates an example of a preview screen relating to display of received image data in a personal computer (PC) according to the first exemplary embodiment.

FIG. 14 is a flowchart illustrating a series of processes for setting information about rotation of image data of a read document in an MFP according to a second exemplary embodiment of the present invention.

FIG. 15 illustrates an example of a setting screen relating to rotation of image data of a read document in the MFP according to the second exemplary embodiment.

FIG. 16 illustrates an example of information about rotation of image data registered in a setting table in the MFP according to the second exemplary embodiment.

FIGS. 17A and 17B respectively illustrate examples of a result of rotating image data according to information registered in the setting table in the MFP according to the second exemplary embodiment.

FIGS. 18A, 18B, 18C, and 18D respectively illustrate configurations according to a third exemplary embodiment.

FIG. 19 is a flowchart illustrating an example of control according to the third exemplary embodiment.

FIG. 20 is a flowchart illustrating an example of control according to the third exemplary embodiment.

FIG. 21 illustrates a configuration according to the third exemplary embodiment.

FIG. 22 illustrates a configuration according to the third exemplary embodiment.

### DESCRIPTION OF THE EMBODIMENTS

Exemplary embodiments of the invention will be described in detail below with reference to the accompanying drawings. The exemplary embodiments, described below, are not intended to limit the claimed invention, and all combinations of features described in the exemplary embodiments are not necessarily essential to solutions to the present invention.

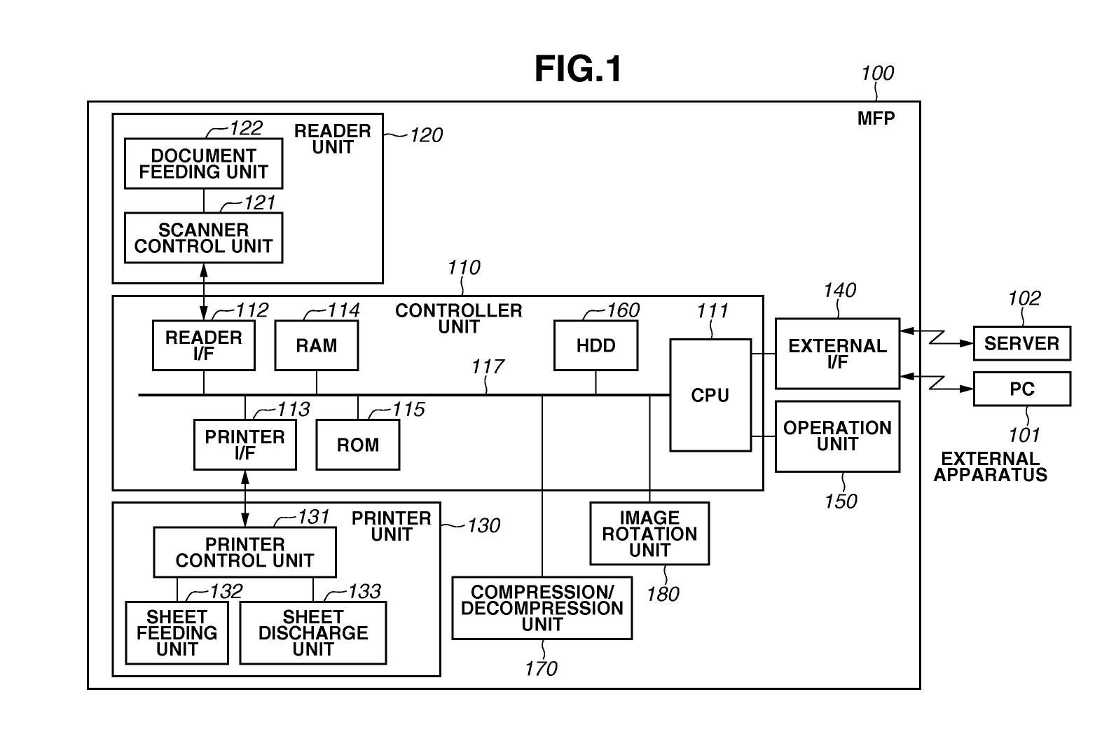

A printing system according to a first exemplary embodiment of the present invention will be described with reference to FIG. 1. The printing system according to the present exemplary embodiment includes a multi functional peripheral (MFP) 100 serving as an example of an image reading apparatus that reads an image on a document, a personal computer (PC) 101 serving as an external information processing apparatus, and a server 102. The MFP 100 has an image reading function for reading the image on the document and a printing function (also referred to as an image forming function) for printing image data of the read document on a sheet. The printing function may be a color printing function or a monochrome printing function. More specifically, the MFP 100 functions as a printing apparatus in addition to a function serving as the image reading apparatus. While the MFP 100 is used as an example of the image reading apparatus in the present exemplary embodiment, the image reading apparatus may be a scanner capable of reading an image on a document and transmitting image data of the read document to the PC 101 if it has an image reading function. Alternatively, the image reading apparatus may be a scanner that does not transmit image data of a read document to the PC 101 but stores the image data in an external memory detachably attached to a universal serial bus (USB).

The MFP 100 is connected to the PC 101 via a local area network (LAN) or a wide area network (WAN) such as the Internet, and communicates with the PC 101. While the MFP 100 and the PC 101 are connected to each other via a wired LAN in the present exemplary embodiment, the MFP 100 and the PC 101 may be connected to each other via a universal serial bus (UBS) cable. The MFP 100 and the PC 101 may be able to communicate with each other through wireless communication such as Wireless Fidelity (Wi-Fi) and Bluetooth (registered trademark).

The PC 101 generates image data using application software, and transmits the generated image data to the MFP 100. While the PC 101 is used as an example of the external information processing apparatus in the present exemplary embodiment, the information processing apparatus is not limited to the PC 101. The information processing apparatus may be a personal digital assistant (PDA) or a portable information terminal such as a smartphone.

On the other hand, the MFP 100 is connected to the server 102 via a network and a video cable (not illustrated). The video cable is used for transferring a print image, and the network is used for exchanging other information. The network used to connect the MFP 100 and the server 102 may be a LAN or a WAN if the functions in the present exemplary embodiment are executed, unless otherwise stated. The server 102 has various functions of image processing, printing control, job management, and user authentication. The server 102 and the PC 101 may be connected to be able to communicate with each other via a network such as a LAN or a WAN or a wireless LAN.

The MFP 100 according to the present exemplary embodiment includes a controller unit (a control unit) 110, a reader unit 120, a printer unit 130, an external interface (I/F) 140, an operation unit 150, a hard disk drive (HDD) 160, a compression/decompression unit 170, and an image rotation unit 180. These units are electrically connected to one another, and transmit and receive a control command and data to and from one another.

The reader unit 120 includes a scanner control unit 121 that controls communication with the controller unit 110, and a document feeding unit (DF unit) 122 that feeds a document. An instruction to read the document with the reader unit 120 is issued from the controller unit 110 via the scanner control unit 121. The reader unit 120 optically reads an image on the document, and converts the image into image data serving as an electric signal. While the instruction to read the document in the reader unit 120 is issued from the controller unit 110 via the scanner control unit 121 in the present exemplary embodiment, the present invention is not limited to such a case. If the reader unit 120 in the MFP 100 does not include the scanner control unit 121 as its component, the instruction to read the document with the reader unit 120 may be directly issued from a central processing unit (CPU) 111 in the controller unit 110.

On the other hand, the printer unit 130 includes a printer control unit 131 that controls communication with the controller unit 110. Further, the printer unit 130 includes a sheet feeding unit 132 including a plurality of sheet holding units (sheet feed stages) that holds sheets used for printing and a sheet discharge unit 133 that performs stapling processing and shift processing to a print product. The printer unit 130 performs print processing of a print target job stored in the HDD 160 in the controller unit 110. An instruction to print the image data with the printer unit 130 is issued from the controller unit 110 via the printer control unit 131. The printer unit 130 forms (prints) an image using toner on the sheet fed from the sheet feed stage based on image data, and transfers and fixes the image data. While the instruction to print the image data with the printer unit 130 is issued from the controller unit 110 via the printer control unit 131 in the present exemplary embodiment, the present invention is not limited to such a case. If the printer unit 130 in the MFP 100 does not include the printer control unit 131 as its component, the instruction to print the image data in the printer unit 130 may directly be issued from the CPU 111 in the controller unit 110.

On the other hand, the controller unit 110 includes a nonvolatile memory such as the HDD 160 capable of storing a plurality of jobs to be processed therein. While the HDD 160 is used as an example of a large-capacity and nonvolatile storage device in the present exemplary embodiment, a nonvolatile memory such as a solid state drive (SSD) may be used if it is a large-capacity and nonvolatile storage device.

The controller unit 110 includes a plurality of functional blocks. For example, the controller unit 110 stores the image data of the document read by the reader unit 120 in the HDD 160, and reads out the image data from the HDD 160. The printer unit 130 can execute a copy job for printing the image data on a sheet. The controller unit 110 can execute a scanner function for converting the image data of the document read by the reader unit 120 into code data and transmitting the code data to the PC 101 serving as an external apparatus via the external I/F 140 serving as an example of a communication unit. The external I/F 140 is an interface for transmitting and receiving the image data to and from the external apparatus. The external apparatus includes a facsimile, a network connection apparatus, and an external dedicated apparatus in addition to the PC 101 and the server 102. The controller unit 110 stores a print job received from the PC 101 and the server 102 via the external I/F 140 in the HDD 160, reads out the print job from the HDD 160, and converts the code data into image data. The printer unit 130 can execute a printing function for printing the image data on the sheet.

The controller unit 110 includes the CPU 111, a read-only memory (ROM) 115, a random access memory (RAM) 114, a reader I/F 112, and a printer I/F 113.

The CPU 111 controls processes and operations of the various types of units provided in the MFP 100. The ROM 115 is dedicated to reading, and previously stores programs such as a boot sequence and font information. On the other hand, the RAM 114 is readable and writable, and stores the image data which is sent from the reader unit 120 or the external I/F 140, various types of programs, and setting information.

The ROM 115 stores various types of control programs to be executed by the CPU 111 and required to perform various types of processing in flowcharts described below. The ROM 115 also stores display control programs used for displaying various types of user interface (UI) screens on a display portion of the operation unit 150, described below. The CPU 111 reads out and executes the programs stored in the ROM 115, to perform various types of operations.

The ROM 115 stores a program used for executing an operation by the CPU 111 interpreting page description language (PDL) data received from the external apparatus via the external I/F 140 and rasterizing the PDL data into raster image data (bit map image data). Similarly, the ROM 115 also stores a program for causing the CPU 111 to interpret and process the print job received from the external apparatus via the external I/F 140. The programs are processed with software.

The HDD 160 can store system software and image data compressed by the compression/decompression unit 170 arranged on a system bus 117. The HDD 160 can retain a plurality of data such as print data of the processing target job. The controller unit 110 stores the processing target job, which has been input via various types of input units such as the reader unit 120 and the external I/F 140, in the HDD 160, reads out the job from the HDD 160, and outputs the job to the printer unit 130. The printer unit 130 prints the job. The controller unit 110 can also transmit the job read from the HDD 160 to the external apparatus via the external I/F 140.

The compression/decompression unit 170 compresses and decompresses the image data stored in the RAM 114 or the HDD 160 using various types of compression systems such as a Joint Bi-level Image Experts Group (JBIG) and a Joint Photographic Experts Group (JPEG). The compression/decompression unit 170 includes an image processing block that can store the image data again in the RAM 114 or the HDD 160. The image data, which has been compressed by the compression/decompression unit 170, can be transmitted to the external apparatus via the external I/F 140.

The controller unit 110 can receive the image data from the external apparatus such as the PC 101 via the external I/F 140. When the image data received via the external I/F 140 is stored in the HDD 160, the compression/decompression unit 170 compresses the image data. On the other hand, when the image data stored in the HDD 160 is printed, the compression/decompression unit 170 decompresses and rasterizes the image data. The controller unit 110 executes various types of output processing of the processing target job stored in the HDD 160. While the HDD 160 is used as an example, a volatile RAM may be used.

The reader I/F 112 is an interface for connection with the reader unit 120 serving as an image input device. The printer I/F 113 is an interface for connection with the printer unit 130 serving as an image output device. The controller unit 110 performs synchronous/asynchronous conversion and control of the image data via the reader I/F 112 and the printer I/F 113.

The controller unit 110 includes the image rotation unit 180 arranged on the system bus 117. The image rotation unit 180 rotates the image data.

The MFP 100 also includes the operation unit 150 corresponding to an example of a user interface unit, and including the display portion. The operation unit 150 in the MFP 100 according to the present exemplary embodiment includes the display portion and a hard key (not illustrated). The display portion includes a liquid crystal display (LCD) and a touch panel sheet including a transparent electrode (which may be of an electrostatic capacitance type). An operation screen and a state of the MFP 100 are displayed on the LCD. The operation unit 150 has a function of receiving various types of settings from the user and a function of providing information to the user via the operation screen or the hard key.

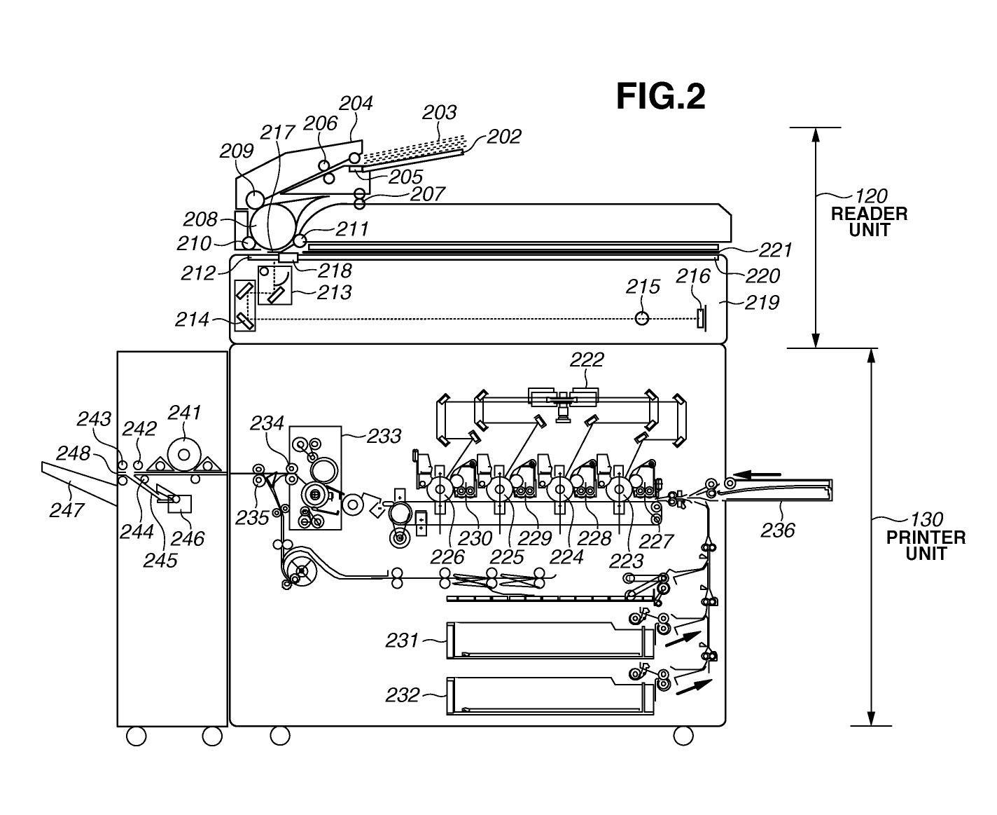

A cross section of the reader unit 120 and the printer unit 130 illustrated in FIG. 1 will be described below with reference to FIG. 2.

In the reader unit 120, information about documents 203 is read while moving the documents 203 relative to an exposure unit 213. More specifically, in the reader unit 120, a document feeding roller 204 and a separation pad 205, which are paired, convey the documents 203 set on a document tray 202 one by one. The conveyed one document 203 is fed into the image reading apparatus via an intermediate roller pair 206, and is then conveyed by a large roller 208 and a roller 209 while being further conveyed by the large roller 208 and a roller 210. The document 203, which has been conveyed between a document glass 212 and a document guide plate 217 while contacting the document glass 212, is further conveyed by the large roller 208 and a roller 211 after passing via a jump stand 218, and is discharged onto a document discharge tray by a document discharge roller pair 207.

When the document 203 passes on the document glass 212, its surface, contacting the document glass 212, is exposed by the exposure unit 213, reflected light from the document 203 obtained as a result thereof is transmitted to a mirror unit 214 via a plurality of mirrors. The transmitted reflected light is converged after passing through a lens 215, and is converted into an electric signal by a charge coupled device (CCD) sensor unit 216. Image data output from the CCD sensor 216 is subjected to predetermined processing, described above, and is then transferred to the controller unit 110. While an optical system provided in the reader unit 120 in the MFP 100 according to the present exemplary embodiment is a reduction optical system for forming an image of the reflected light from the document 203 on a charge coupled device (CCD) sensor, the present invention is not limited to such a case. The optical system provided in the reader unit 120 may be an equal magnification optical system for forming an image of the reflected light from the document on a contact image sensor (CIS).

Then, a laser unit 222 converts the image data, which has been output from the controller unit 110 and transferred to the printer unit 130, into laser light corresponding to the image data. Photosensitive drums 223 to 226 are irradiated with the laser light, and latent images corresponding to the laser light are respectively formed on the photosensitive drums 223 to 226. Development units 227 to 230 respectively cause a developer to adhere to portions of the latent images on the photosensitive drums 223 to 226. In a color machine, four photosensitive drums and four development units are respectively provided therein for cyan, yellow, magenta, and black colors.

The printer unit 130 includes sheet feeding cassettes 231 and 232 of a drawer case shape as the sheet holding unit (sheet feed stage) and a manual feed tray 236 included in the sheet feeding unit 132. The sheet feeding cassettes 231 and 232 and the manual feed tray 236 can retain a plurality of sheets. The printer unit 130 may include a plurality of sheet feeding cassettes and a plurality of manual feed trays, or may include at least one of the sheet feeding cassette and the manual feed tray.

The printer unit 130 feeds a sheet from any one of the sheet feeding cassettes 231 and 232 and the manual feed tray 236, transfers the developer, which has adhered to the photosensitive drums 223 to 226, onto the sheet, and conveys the sheet to a fixing device 233. The fixing device 233 fixes the developer to the sheet with heat and pressure. Conveyance rollers 234 and 235 convey the sheet, which has passed through the fixing device 233, to the sheet discharge unit 133. The sheet, which has been conveyed to the sheet discharge unit 133, is first fed to a buffer unit 241 in the sheet discharge unit 133. The conveyed sheet is wound around a buffer roller depending on the situation, to perform buffering. If it takes time to perform stapling processing performed downstream thereof, for example, a conveyance interval of the sheets conveyed from an apparatus main body can be adjusted by using the buffer unit 241.

The sheet is then stacked on a stack tray 245 via a conveyance path 244 by an upstream discharge roller pair 242 and a downstream discharge roller pair 243. If a sheet bundle in a single copy is stacked on the stack tray 245, the stacked sheet bundle is discharged to a sheet discharge tray 247 via a conveyance path 248.

When designated to be shifted, the sheet bundle stacked on the stack tray 245 is shifted from a sheet bundle, which has been discharged just before, and is discharged to the sheet discharge tray 247 so that a break between copies is easy to recognized by the user.

When designated to be stapled, the sheet bundle, which has been conveyed by the upstream discharge roller pair 242 and stacked on the stack tray 245 via the conveyance path 244 by the downstream discharge roller pair 243, is subjected to stapling processing by a stapling unit 246. The downstream discharge roller pair 243 discharges the stapled sheet bundle to the sheet discharge tray 247.

While a color machine including four photosensitive drums and four development units is used in the present exemplary embodiment, the present invention is also similarly applicable to a monochrome machine including one photosensitive drum and one development unit. While a method for printing an image on a sheet using an electrophotographic system is used in the present exemplary embodiment, an inkjet system or another system may be used if it can print an image.

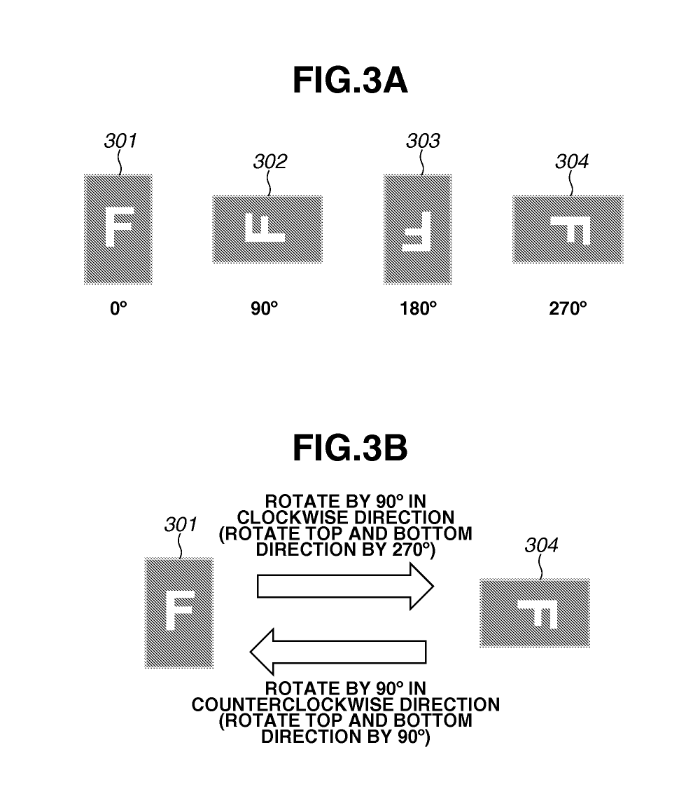

In the MFP 100 according to the first exemplary embodiment, a top and bottom direction of an image on a document and rotation of the image on the document will be then described with reference to FIG. 3. In the present exemplary embodiment, the top and bottom direction of the image on the document is defined, as illustrated in FIG. 3A, using a direction as a reference in which the document 203 set in the document feeding unit 122 is conveyed when the reader unit 120 reads an image on the document 203. More specifically, top and bottom directions of images 301, 302, 303, and 304 on the document 203 are respectively 0 degrees, 90 degrees, 180 degrees, and 270 degrees. The image 301 on the document 203, the top and bottom direction of which is 0 degrees, is changed into the image 304 on the document 203, the top and bottom direction of which is 270 degrees, when rotated by 90 degrees in a clockwise direction, as illustrated in FIG. 3B. Similarly, the image 304 on the document 203, the top and bottom direction of which is 270 degrees, is changed into the image 301 on the document 203, the top and bottom direction of which is 0 degrees, when rotated by 90 degrees in a counterclockwise direction, as illustrated in FIG. 3B. More specifically, the rotation by degrees in the clockwise direction corresponds to rotation of the top and bottom direction by 270 degrees, and the rotation by 90 degrees in the counterclockwise direction corresponds to rotation of the top and bottom direction by 90 degrees.

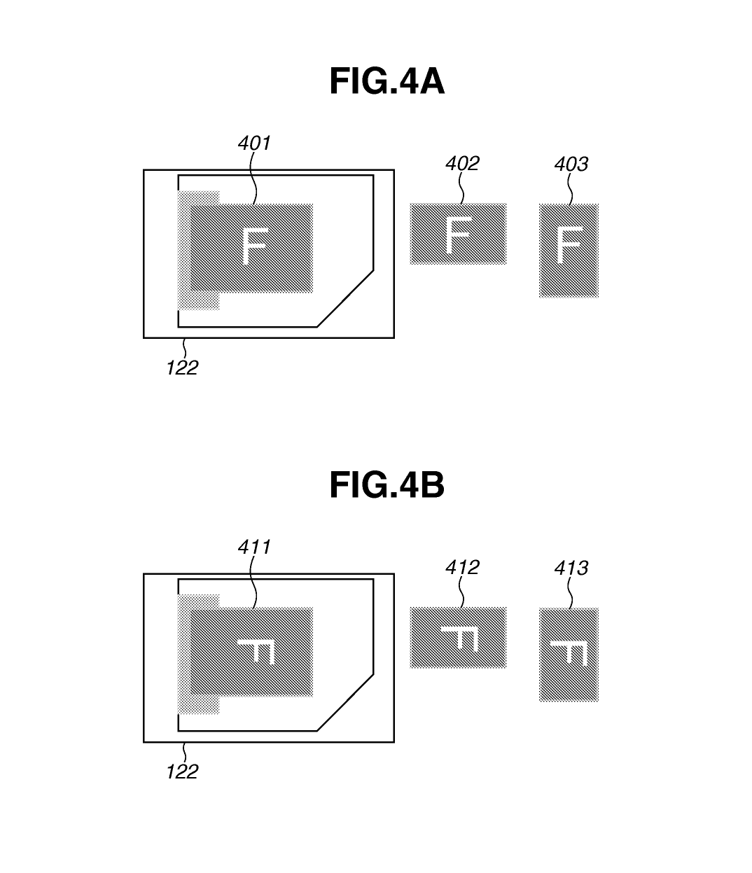

In the MFP 100 according to the first exemplary embodiment, a top and bottom direction of an image on a document 203 set in the document feeding unit 122 will be described below with reference to FIG. 4.

If a document 401 including an image, a top and bottom direction of which is 0 degrees, is set in the document feeding unit 122, as illustrated in FIG. 4A, a top and bottom direction of image data of the read document 401 is 0 degrees. Similarly, even if documents 402 and 403 respectively including images, top and bottom directions of which are 0 degrees, are set in the document feeding unit 122, top and bottom directions of image data of the read documents 402 and 403 are 0 degrees. In the first exemplary embodiment, the fact that the top and bottom direction of the image on the document set in the document feeding unit 122 is “top” is used as a basis.

On the other hand, if a document 411 including an image, a top and bottom direction of which is 90 degrees, is set in the document feeding unit 122, as illustrated in FIG. 4B, a top and bottom direction of image data of the read document 411 is 270 degrees. Similarly, even if documents 412 and 413 respectively including images, top and bottom directions of which are 270 degrees, are set in the document feeding unit 122, top and bottom directions of image data of the read documents 412 and 413 are 270 degrees. More specifically, to set the top and bottom direction of the image data of the read document to 0 degrees, the image data needs to be rotated by 90 degrees in the counterclockwise direction (the top and bottom direction thereof needs to be rotated by 90 degrees).

In the first exemplary embodiment, the fact that the top and bottom direction of the image on the document set in the document feeding unit 122 is 0 degrees is used as a basis.

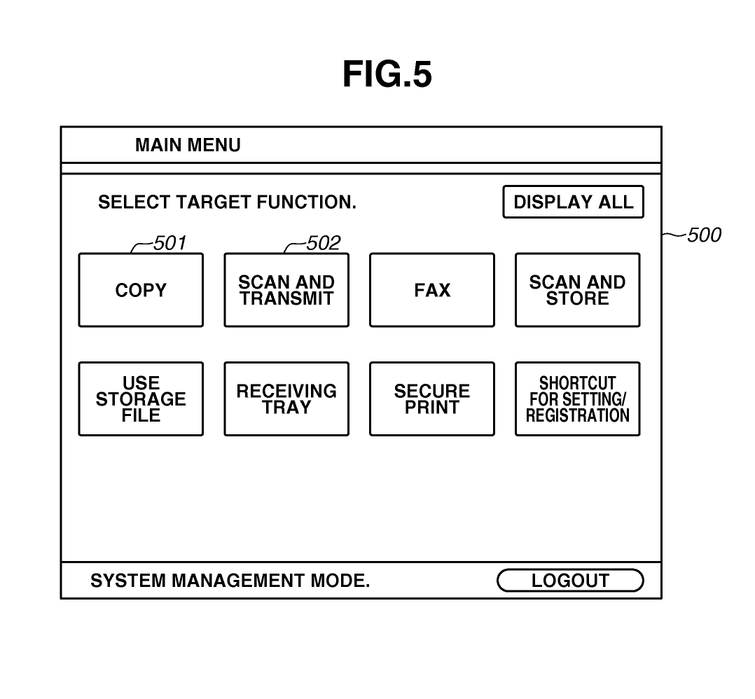

In the MFP 100 according to the first exemplary embodiment, an example of a main screen 500 displayed on the operation unit 150 is illustrated in FIG. 5. The main screen 500 in the first exemplary embodiment includes selection buttons for calling various types of functions such as a copy function 501 and a scan and transmit function 502. The main screen 500 is configured to shift to a screen for using each of the various types of functions when the user presses the desired selection button. In the first exemplary embodiment, it is assumed that the main screen 500 shifts to a screen for executing the scan and transmit function 502 when the selection button for calling the scan and transmit function 502 is pressed.

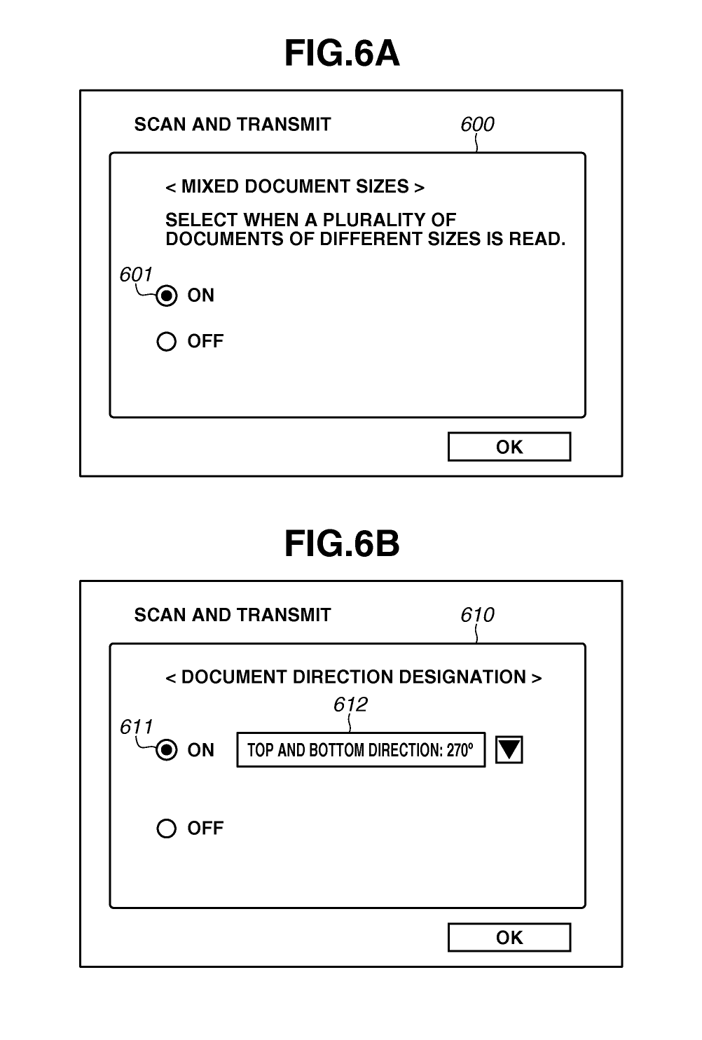

In the MFP 100 according to the first exemplary embodiment, setting screens 600 and 610 for respectively setting mixed document size and document direction designation modes will be described below with reference to FIG. 6.

Details of the mixed document size mode will be first described. As illustrated in FIG. 6A, on the setting screen 600 relating to mixed document sizes, if a plurality of documents of different sizes is set in the document feeding unit 122 to read images on the documents, a mixed document mode 601 is set to ON.

If the mixed document mode 601 is set to ON, every time the document corresponding to one page is read, a memory area corresponding to the length in a sub-scanning direction of the read document is secured. If the size of the first-page document is A4, for example, a memory area corresponding to A4 is secured to store image data of the first-page document. On the other hand, if the size of the second-page document is A3, a memory area corresponding to A3 is secured to store image data of the second-page document.

On the other hand, if the mixed document mode 601 is set to OFF, a memory area corresponding to the length in the sub-scanning direction of the first-page document is secured for all the documents to be read. If the size of the first-page document is A4, for example, a memory area corresponding to A4 is secured to store image data of the first-page document. On the other hand, even if the sizes of the second-page document and the subsequent documents are A3, respective memory areas to be secured to store image data of the second-page document and the subsequent documents are memory areas corresponding to A4.

More specifically, if a plurality of documents of different sizes is set in the document feeding unit 122, to read images on the documents, the mixed document mode 601 may be set to ON. On the other hand, if a plurality of documents of the same size is set in the document feeding unit 122, to read images on the documents, the mixed document mode 601 may be set to OFF.

Details of the document direction designation mode will be then described. As illustrated in FIG. 6B, on the setting screen 610 relating to document direction designation, if image data of a document to be read is rotated to cause a top and bottom direction of the image data to match 0 degrees, and is transmitted to the external apparatus such as the PC 101, a direction designation mode 611 is set to ON.

If the direction designation mode 611 is set to ON, a top and bottom direction 612 of an image on the document set in the document feeding unit 122 is further set. All image data of the read documents are collectively rotated according to information about the set top and bottom direction 612, and are transmitted to the external apparatus with top and bottom directions of the image data matching 0 degrees. If the direction designation mode 611 is set to ON, and the top and bottom direction 612 is set to 270 degrees, for example, the image data of the read document is to be rotated by 90 degrees in the counterclockwise direction (the top and bottom direction is to be rotated by 90 degrees) to cause the top and bottom direction of the image data to match 0 degrees. On the other hand, if the direction designation mode 611 is set to OFF, the image data of the read document is not rotated.

More specifically, if the top and bottom direction of the image on the document set in the document feeding unit 122 is 270 degrees, the direction designation mode 611 may be set to ON. On the other hand, if the top and bottom direction of the image on the document set in the document feeding unit 122 is 0 degrees, the direction designation mode 611 may be set to OFF.

In this way, control can be performed as to whether the image data of the read document is to be rotated according to a setting content (ON/OFF) of the direction designation mode 611.

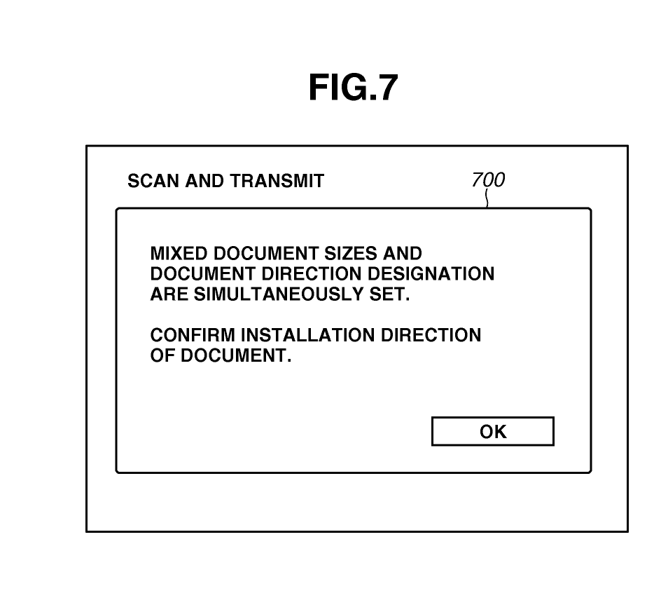

If the mixed document mode 601 and the direction designation mode 611 are simultaneously set to ON, a warning screen 700 as illustrated in FIG. 7 may be displayed on the operation unit 150 to urge the user to confirm a top and bottom direction of an image on a document set in the document feeding unit 122. If images on a plurality of documents of different sizes are read, the documents respectively including images, the top and bottom directions of which are 90 degrees, and the documents respectively including images, the top and bottom directions of which are 270 degrees, can be mixed in the document feeding unit 122, and the documents respectively including images, the top and bottom directions of which are 0 degrees, and the documents respectively including images, the top and bottom directions of which are 180 degrees, can be mixed in the document feeding unit 122. In such a case, top and bottom directions of image data, which have collectively been rotated, may not match 0 degrees according to information about the set top and bottom direction 612.

In the first exemplary embodiment, before respective images on a plurality of documents set in the document feeding unit 122 are continuously read, the read document is designated in a page unit to rotate its image data while an angle at which the image data is to be rotated is designated. Thus, even if the plurality of documents respectively including the images, which are different in top and bottom directions, is set in the document feeding unit 122, top and bottom directions of the image data of the read documents can be caused to easily match one another.

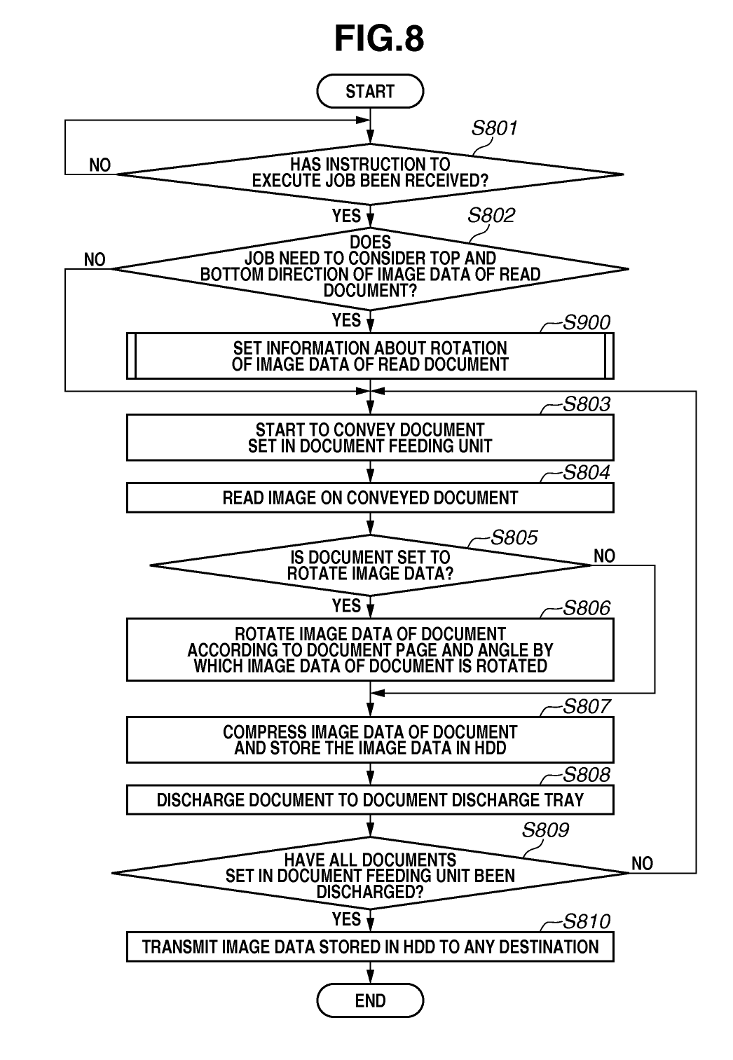

In the MFP 100 according to the first exemplary embodiment, a series of processes for continuously reading images on a plurality of documents set in the document feeding unit 122 and transmitting image data of the read documents will be described with reference to a flowchart illustrated in FIG. 8. Processing illustrated in FIG. 8 is started while the selection button for calling the scan and transmit function 502 is pressed and the main screen 500 shifts to the screen for executing the scan and transmit function 502. The processing is started while the mixed document mode 601 and the direction designation mode 611 are simultaneously set to ON. Each of the processes in the flowchart illustrated in FIG. 8 is implemented when the CPU 111 executes a program read from the ROM 115 or the HDD 160 and loaded into the RAM 114.

In step S801, the CPU 111 first determines whether an instruction to execute a job has been received by pressing a start key (not illustrated) in the operation unit 150. If the CPU 111 determines that the instruction to execute the job has been received (YES in step S801), the processing proceeds to step S802. Otherwise (NO in step S801), the process in step S801 is repeated until the CPU 111 determines that the instruction to execute the job has been received.

In step S802, the CPU 111 determines whether the job, which has been instructed to be executed in step S801, needs to consider a top and bottom direction of image data of a document read by the reader unit 120. The job, which needs to consider the top and bottom direction of the image data of the read document, includes a job designated to read a document including only characters or a document including a mixture of characters and pictures as a document type and transmit image data of the document to any destination via the external I/F 140. Depending on setting of a file format when a document is read to generate image data, a character code corresponding to characters in the read document is embedded in the image data. Therefore, the characters in the document need to correctly be recognized in a correct direction.

On the other hand, even in a job designated to be transmitted to any destination, when a document including no characters and including only pictures is read as a document type, a character code is not embedded in the image data of the read document. Therefore, a top and bottom direction of the image data need not be considered.

If the type of the document to be read is a document including only characters or a document including a mixture of characters and pictures, the CPU 111 determines that the job needs to consider the top and bottom direction of the image data of the read document (YES in step S802). On the other hand, if the type of the document to be read is a document including only pictures, the CPU 111 determines that the job need not consider the top and bottom direction of the image data of the read document (NO in step S802).

Alternatively, when the image data of the document is converted into one file, if a file format for embedding a character code in the image data is set as the file format of the file, the CPU 111 determines that the job needs to consider the top and bottom direction of the image data of the read document (YES in step S803). On the other hand, if a file format for not embedding a character code in the image data is set, the CPU 111 determines that the job need not consider the top and bottom direction of the image data of the read document (NO in step S802).

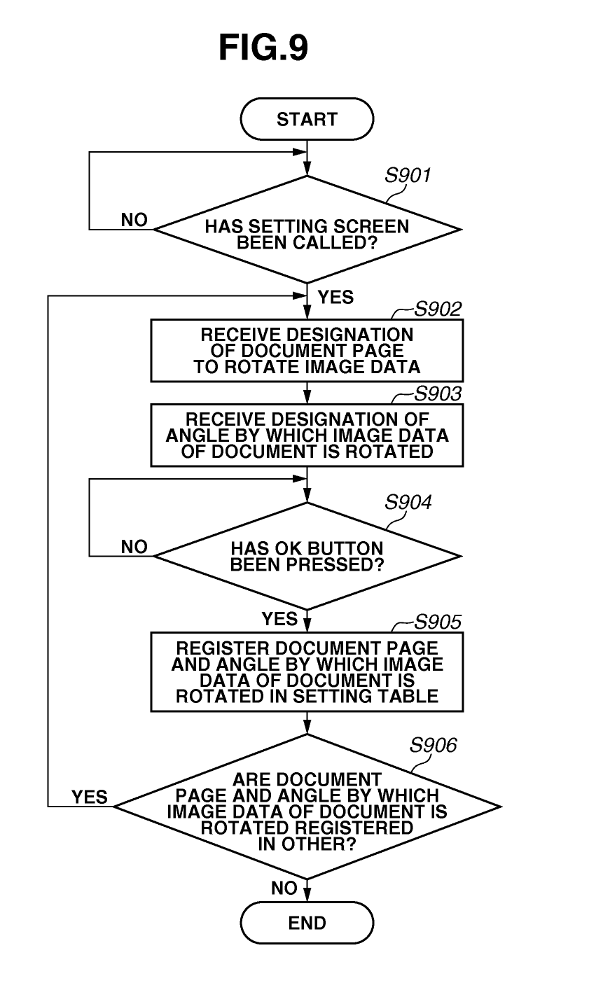

Even if documents including only pictures are read as a document type, the user may desire to cause top and bottom directions of image data of the read documents to match one another. In this case, even if the documents including only pictures are read as a document type, determination whether an operation for causing the top and bottom directions of the image data of the read documents to match one another (details thereof will be described below with reference to FIG. 9) is performed may be switchable according to setting by the user.

If the CPU 111 determines that the job needs to consider the top and bottom direction of the image data of the read document (YES in step S802), the processing proceeds to step S900. Otherwise (NO in step S802), the processing proceeds to step S803.

As for step S900 illustrated in FIG. 8 in the first exemplary embodiment, a series of processes for setting information about rotation of the image data of the read document will be described with reference to a flowchart illustrated in FIG. 9. The processes in the flowchart illustrated in FIG. 9 are implemented when the CPU 111 executes the program read from the ROM 115 or the HDD 160 and loaded into the RAM 114.

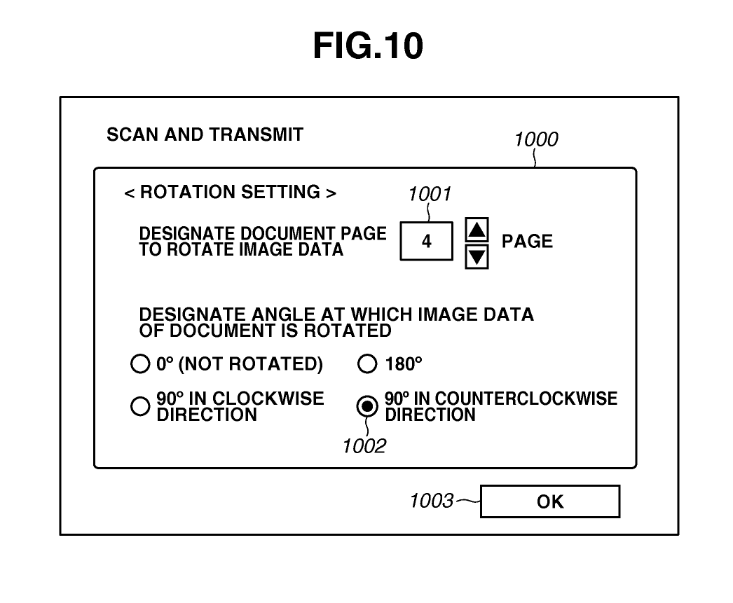

In step S901, the CPU 111 determines whether a setting screen 1000 illustrated in FIG. 10 relating to rotation of image data of a read document has been called. If the CPU 111 determines that the setting screen 1000 has been called (YES in step S901), the processing proceeds to step S902. Otherwise (NO in step S901), the process in step S901 is repeated until the CPU 111 determines that the setting screen 1000 has been called.

In step S902, the CPU 111 receives designation 1001 of a document page corresponding to the document to rotate its image data on the setting screen 1000 illustrated in FIG. 10, and the processing proceeds to step S903.

In step S903, the CPU 111 receives designation 1002 of an angle by which the image data of the document is to be rotated on the setting screen 1000 illustrated in FIG. 10, and the processing proceeds to step S904. The designation 1002 of the angle by which the image data of the document is to be rotated is 0 degrees, 180 degrees, 90 degrees (90 degrees in the clockwise direction), and 270 degrees (90 degrees in the counterclockwise direction), and the angle can be designated to be a predetermined angle in units of 90 degrees. The designation 1002 of the angle by which the image data of the document is to be rotated may be designated to be a predetermined angle in units of one degree.

In step S904, the CPU 111 determines whether an OK button 1003 has been pressed on the setting screen 1000 illustrated in FIG. 10. If the CPU 111 determines that the OK button 1003 has been pressed (YES in step S904), the processing proceeds to step S905. Otherwise (NO in step S904), the process in step S904 is repeated until the CPU 111 determines that the OK button 1003 has been pressed.

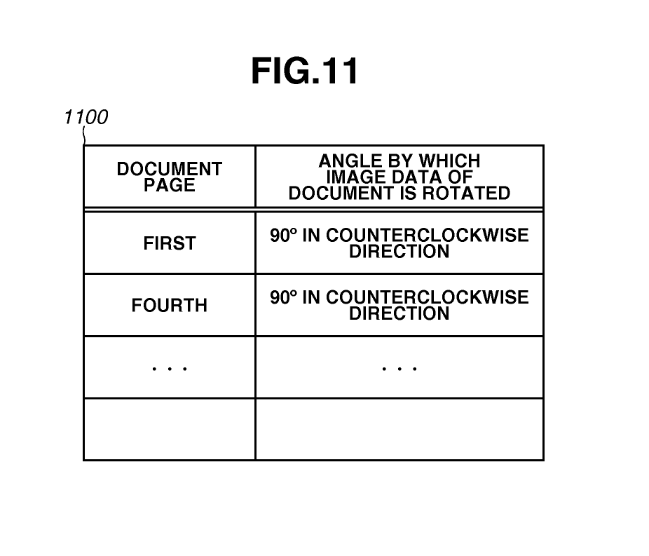

In step S905, the CPU 111 registers the document page, which has been received in step S902, and the angle by which the image data is to be rotated, which has been received in step S903, in a setting table 1100 illustrated in FIG. 11. Setting information registered in the setting table 1100 is stored in the RAM 114 or the HDD 160.

In step S906, the CPU 111 determines whether the document page and the angle by which the image data is to be rotated are registered in others. If the CPU 111 determines that the document page and the angle are registered in others (YES in step S906), the processing returns to step S902. The CPU 111 performs the process in step S902 and the subsequent processes. Otherwise (NO in step S906), the CPU 111 ends the series of processes (the processing in step S900 illustrated in FIG. 8) for setting the information about the rotation of the image data of the read document, and the processing proceeds to step S803.

In step S803, the CPU 111 issues an instruction to start to convey the document set in the document feeding unit 122, and the processing proceeds to step S804.

In step S804, the CPU 111 instructs the reader unit 120 to read the image on the conveyed document, and the processing proceeds to step S805.

In step S805, the CPU 111 refers to the document page and the angle by which the image data is to be rotated, which have been registered in the setting table 1100, and determines whether the document, which has been read in step S804, has been designated to rotate the image data. If the CPU 111 determines that the document has been designated to rotate the image data (YES in step S805), the processing proceeds to step S806. Otherwise (NO in step S805), the processing proceeds to step S807.

If the angle by which the image data is to be rotated is designated as 0 degrees (the image data is not rotated), the image data is considered not to have been designated to rotate the image data, and the CPU 111 determines that the read document has not been designated to rotate the image data (NO in step S805). Even if the document page corresponding to the document, which has been read in step S804, is not subjected to the designation 1001 to rotate the image data on the setting screen 1000, the image data is also considered not to have been designated to rotate the image data, and the CPU also determines that the read document has not been designated to rotate the image data (NO in step S805).

In step S806, the CPU 111 causes the image rotation unit 180 to rotate the image data of the document, which has been read in step S804, according to the document page and the angle by which the image data is to be rotated, which have been registered in the setting table 1100, and the processing proceeds to step S807.

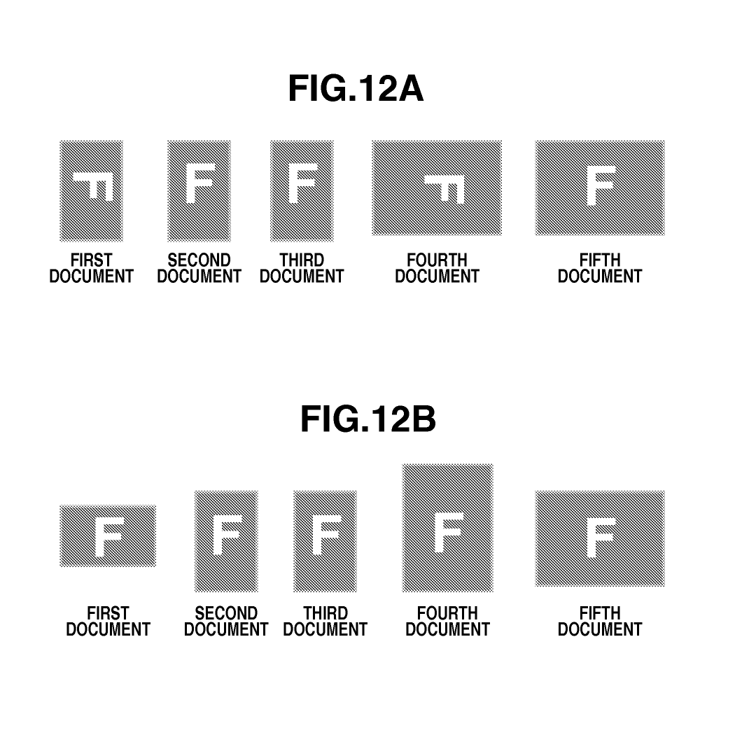

An example of a result of rotating the image data of the read document according to the document page and the angle by which the image data is to be rotated, which have been registered in the setting table 1100, will be described with reference to FIG. 12.

If image data of first and fourth documents have been registered to rotate by 90 degrees in the counterclockwise direction, for example, in the setting table 1100 illustrated in FIG. 11, the CPU 111 determines that the first and fourth documents among the documents illustrated in FIG. 12A have been designated to rotate the image data (YES in step S805). On the other hand, the CPU 111 determines that second, third, and fifth documents have not been designated to rotate the image data (NO in step S805). Top and bottom directions of the first and fourth documents are 270 degrees, and top and bottom directions of the second, third, and fifth documents are 0 degrees. Therefore, in step S806, the CPU 111 rotates the image data of the first and fourth documents according to the angle by which the image data is to be rotated, which has been registered in the setting table 1100. On the other hand, the CPU 111 does not rotate the image data of the second, third, and fifth documents. The image data of the first and fourth documents, which have been rotated in step S806, are rotated by 90 degrees in the counterclockwise direction, as illustrated in FIG. 12B. Thus, even if the plurality of documents respectively including images, which are different in top and bottom directions, is mixed and set in the document feeding unit 122, top and bottom directions of the image data of the documents can be caused to match 0 degrees.

In step S807, the CPU 111 causes the compression/decompression unit 170 to compress the image data of the document, which has been read in step S804, or the image data which has been rotated in step S806. After the image data is compressed, the compressed image data is stored in the HDD 160, and the processing proceeds to step S808.

In step S808, the CPU 111 issues an instruction to discharge the document, which has been conveyed in step S803, onto the document discharge tray, and the processing proceeds to step S809.

In step S809, the CPU 111 determines whether all the documents set in the document feeding unit 122 have been discharged onto the document discharge tray. If the CPU determines that the documents have not been discharged (NO in step S809), the processing returns to step S803. The CPU 111 performs the process in step S803 and the subsequent steps. If the CPU 111 determines that the documents have been discharged (YES in step S809), the processing proceeds to step S810.

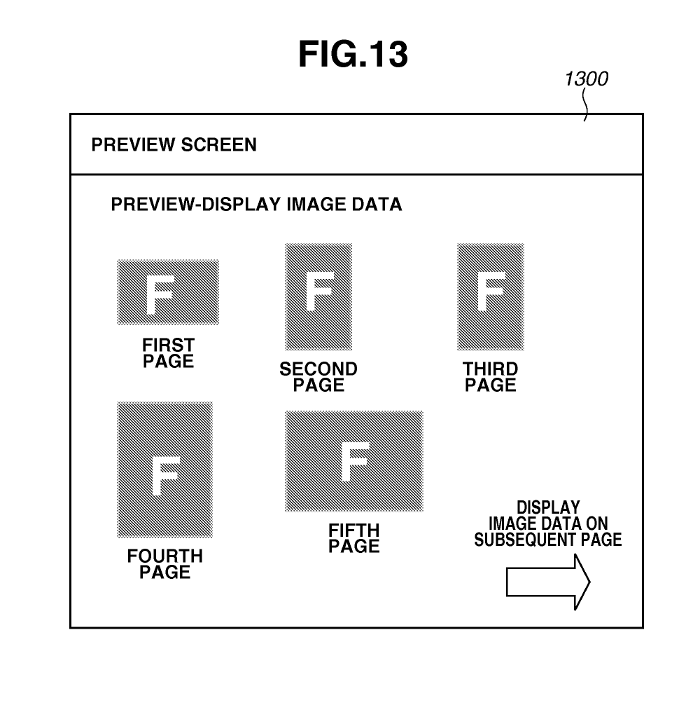

In step S810, the CPU 111 reads out the image data, which has been stored in the HDD 160 in step S807, and transmits the image data to any destination via the external I/F 140. The external apparatus such as the PC 101 receives the image data, which has been transmitted in step S810, and displays a preview screen 1300 illustrated in FIG. 13 in an operation unit provided in the PC 101. The user can confirm the image data, the top and bottom directions of which match 0 degrees without rotating the received image data on the preview screen 1300.

The details of the series of processes for continuously reading the images on the plurality of documents and transmitting the image data of the read documents in the MFP 100 according to the first exemplary embodiment have been described. While the CPU 111 transmits the image data stored in the HDD 160 to any destination and preview-displays the image data in the operation unit provided in the PC 101 in step S807, the present invention is not limited to such a case. The CPU 111 may refer to the image data stored in the HDD 160 and preview-display the image data in the operation unit 150 provided in the MFP 100. While the CPU 111 performs the processing in step S900 for setting the information about the rotation of the image data of the read document is performed after receiving the instruction to execute the job, the present invention is not limited to such a case. The CPU 111 may previously perform the processing in step S900 before receiving the instruction to execute the job, or may import the information about the rotation of the image data of the document via the server 102. If user authentication is performed before the instruction to execute the job is received and the setting table 1100 is held for each user, for example, the CPU 111 can refer to the information registered in the setting table 1100 according to the user authentication, and import the information about the rotation of the image data of the document.

While the series of processes illustrated in FIG. 8 is started while the selection button for calling the scan and transmit function 502 is pressed and the main screen 500 shifts to the screen for executing the scan and transmit function 502, the present invention is not limited to such a case. The present invention is similarly applicable to the processes in steps S801 to S809 illustrated in FIG. 8 even while a selection button for calling the copy function 501 is pressed and the main screen 500 shifts to a screen for executing the copy function 501. In this case, in step S810, the CPU 111 reads out the image data, which has been stored in the HDD 160 in step S807, and causes the printer unit 130 to print the image data on the sheet. In this case, in step S802, the CPU may determine whether the job needs to consider the top and bottom direction of the image data of the read document depending on whether the job is designated to staple the image data of the document after printing the image data on the sheet.

As described above, in the first exemplary embodiment, before the images on the plurality of documents set in the document feeding unit 122 are continuously read, the read document is designated in a page unit to rotate the image data while the angle by which the image data is to be rotated is designated. Thus, even if the plurality of documents respectively including images, which are different in top and bottom directions, is set in the document feeding unit 122, the image data of the read documents are rotated according to the designation of the document pages so that the top and bottom directions of the image data can easily made to match one another.

In the first exemplary embodiment, when the information about the rotation of the image data of the read documents is set, the read document is designated in a page unit to rotate the image data while the angle by which the image data is to be rotated is designated. However, the present invention is not limited to such a case. If all the top and bottom directions of the images on the plurality of documents set in the document feeding unit 122 are the same, for example, the image data can collectively be rotated without the angle by which the image data of the document is to be rotated being designated in a page unit. On the other hand, if the document page and the angle by which the image data is to be rotated have been registered in the setting table 1100 to rotate the image data of the document in a page unit, the image data of the document is preferentially rotated in a page unit. Thus, the processing for collectively rotating the image data is limited.

In the above-described first exemplary embodiment, a read document is designated in a page unit to rotate its image data while an angle by which the image data is to be rotated is designated.

On the other hand, in a second exemplary embodiment, a read document is designated depending on the size thereof to rotate its image data while an angle by which the image data is to be rotated is designated.

In the second exemplary embodiment, a flowchart illustrating a series of processes for continuously reading images on a plurality of documents and transmitting image data of the read documents is similar to that illustrated in FIG. 8, and therefore description thereof is not repeated.

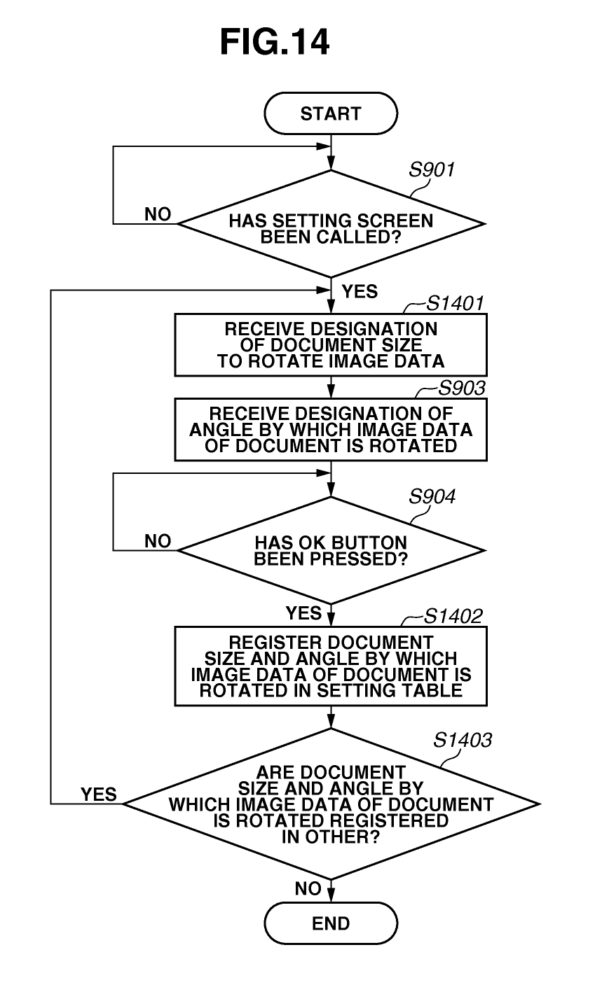

On the other hand, in the second exemplary embodiment, some operations in processing in step S800 for setting information about the rotation of the image data of the read documents differs from those in the first exemplary embodiment. Operations common to those in the processing in the first exemplary embodiment are assigned the same step numbers, and detailed description thereof is omitted. Operations which are different from those in the processing in the first exemplary embodiment will be mainly described with reference to a flowchart illustrated in FIG. 14. Processes in the flowchart illustrated in FIG. 14 are implemented when a CPU 111 executes a program read from a ROM 115 or a HDD 160 and loaded into a RAM 114.

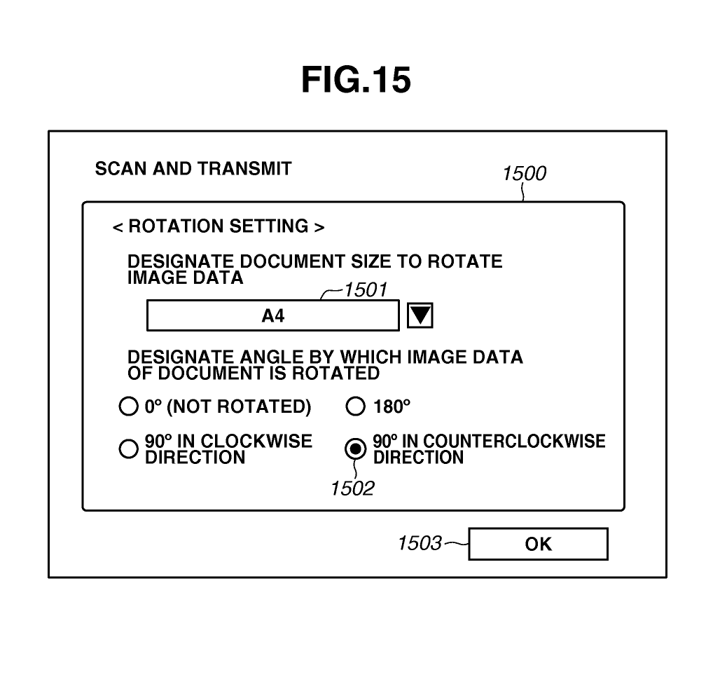

In step S901, the CPU 111 determines whether a setting screen 1500 illustrated in FIG. 15 for setting information about rotation of image data of read documents has been called. If the CPU 111 determines that the setting screen 1500 has been called (YES in step S901), the processing proceeds to step S1401.

In step S1401, the CPU 111 receives designation 1501 of a document size of a document to rotate its image data on the setting screen 1500 illustrated in FIG. 15, and the processing proceeds to step S903.

In step S903, the CPU 111 receives designation 1502 of an angle by which the image data of the document is to be rotated on the setting screen 1500 illustrated in FIG. 15, and the processing proceeds to step S904.

In step S904, the CPU 111 determines whether an OK button 1503 has been pressed on the setting screen 1500 illustrated in FIG. 15. If the CPU 111 determines that the OK button 1503 has been pressed (YES in step S904), the processing proceeds to step S1402.

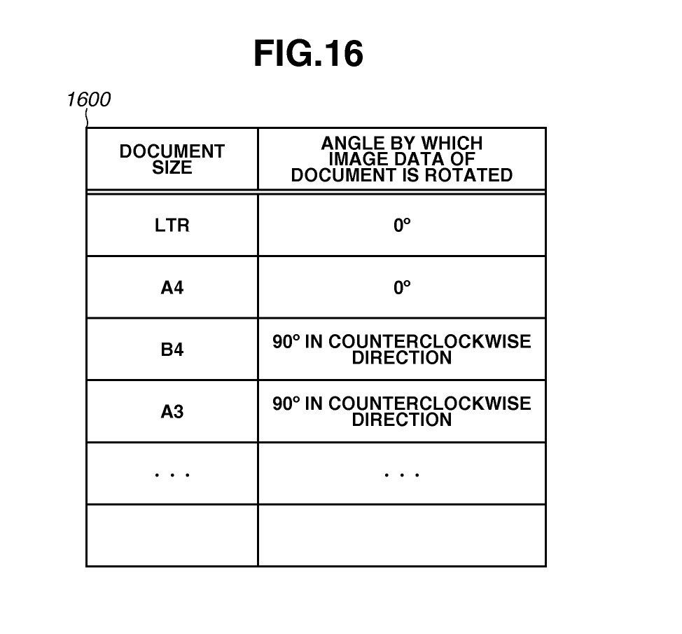

In step 1402, the CPU 111 registers the document size, which has been received in step S1401, and the angle by which the image data is to be rotated, which has been received in step S903, in a setting table 1600 illustrated in FIG. 16, and the processing proceeds to step S1403. Setting information, which has been registered in the setting table 1600, is stored in the RAM 114 or the HDD 160.

In step S1403, the CPU 111 determines whether the document size and the angle by which the image data is to be rotated are registered in others. If the CPU 111 determines that the document size and the angle are registered in others (YES in step S1403), the processing returns to step S1401. The CPU 111 performs the process in step S1401 and the subsequent steps. On the other hand, if the CPU 111 determines that the document size and the angle are not registered in others (NO in step S1403), the CPU 111 ends the series of processes according to the second exemplary embodiment for setting the information about the rotation of the image data of the read documents, and the processing proceeds to step S803 illustrated in FIG. 8.

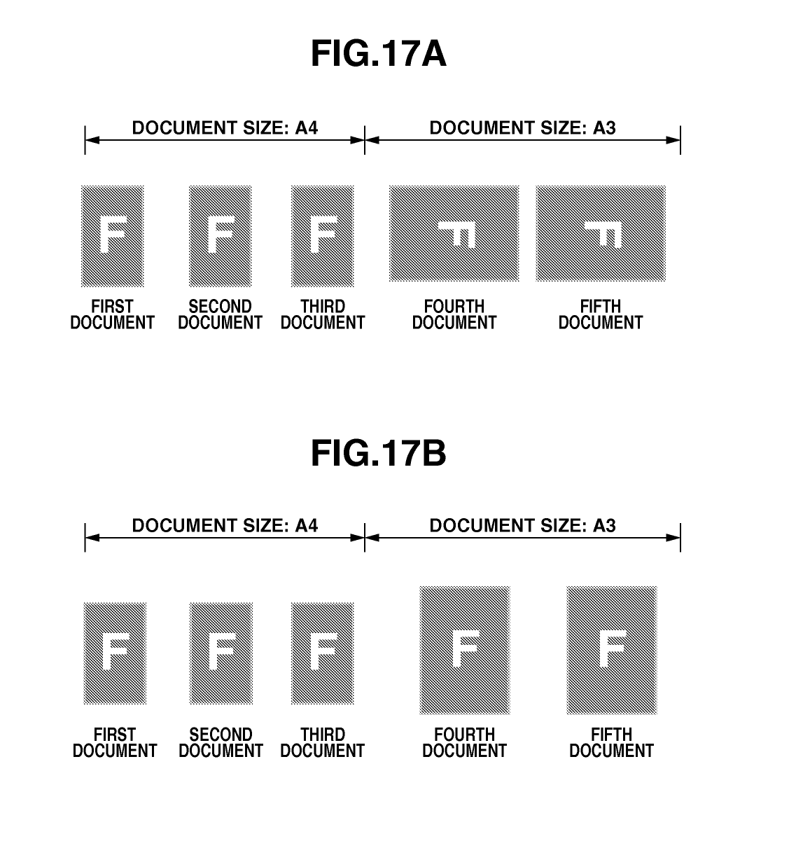

In the second exemplary embodiment, an example of a result of rotating the image data of the read document according to the document size and the angle by which the image data is to be rotated, which have been registered in the setting table 1600, will be described with reference to FIG. 17.

In the setting table 1600 illustrated in FIG. 16, image data of a document, which has been read by a reader unit 120, has been registered to rotate by 90 degrees in a counterclockwise direction if the size of the read document is B4 or A3, for example. On the other hand, image data of a read document has been registered to rotate by 0 degrees if the size of the read document is Letter (LTR) or A4.

If the size of the document, which has been read by the reader unit 120, is A5, information about the A5 size has not been registered in the setting table 1600 illustrated in FIG. 16. In such a case, the image data of the read document is considered to have been registered to rotate by 0 degrees (that is, not to rotate).

For example, among documents illustrated in FIG. 17A, the first, second, and third documents, which are A4 in document size, have been registered to rotate by 0 degrees (i.e., not to rotate). Thus, the CPU 111 determines that the read document has not been designated to rotate the image data (NO in step S805). On the other hand, the fourth and fifth documents, which are A3 in document size, have been registered to rotate by 90 degrees in the counterclockwise direction. Therefore, the CPU 111 determines that the document has been designated to rotate the image data (YES in step S805). Top and bottom directions of images on the first, second, and third documents of the document size A4 are 0 degrees, and top and bottom directions of images on the fourth and fifth documents of the document size A3 are 270 degrees. Thus, the CPU 111 does not rotate the image data of the first, second, and third documents. On the other hand, the CPU 111 rotates the image data of the fourth and fifth documents according to the angle by which the image data is to be rotated, which has been registered in the setting table 1600 illustrated in FIG. 16.

The image data of the fourth and fifth documents, which have been rotated in step S806, are rotated by 90 degrees in the counterclockwise direction, as illustrated in FIG. 17B. Thus, even if the plurality of documents respectively including images, which are different in top and bottom directions, are mixed and set in the document feeding unit 122, top and bottom directions of the image data of the documents can be caused to match 0 degrees.

As described above, in the second exemplary embodiment, before the images on the plurality of documents set in the document feeding unit 122 are continuously read, the read document is designated depending on the size thereof to rotate the image data while the angle by which the image data is to be rotated is designated. Thus, even if the plurality of documents respectively including images, which are different in top and bottom directions, are set in the document feeding unit 122, the image data of the read document is to be rotated according to the designation of the document depending on the size thereof so that the top and bottom directions of the image data can easily be caused to match one another.

In a third exemplary embodiment, before images on a plurality of documents set in a document feeding unit 122 are continuously read, the tops of the images on the documents set in the document feeding unit 122 are designated in a document page unit. Thus, even if the plurality of documents respectively including the images, which are different in the top, is set in the document feeding unit 122, the tops of image data of the documents to be transmitted to an external apparatus such as a PC 101 can be caused to match one another.

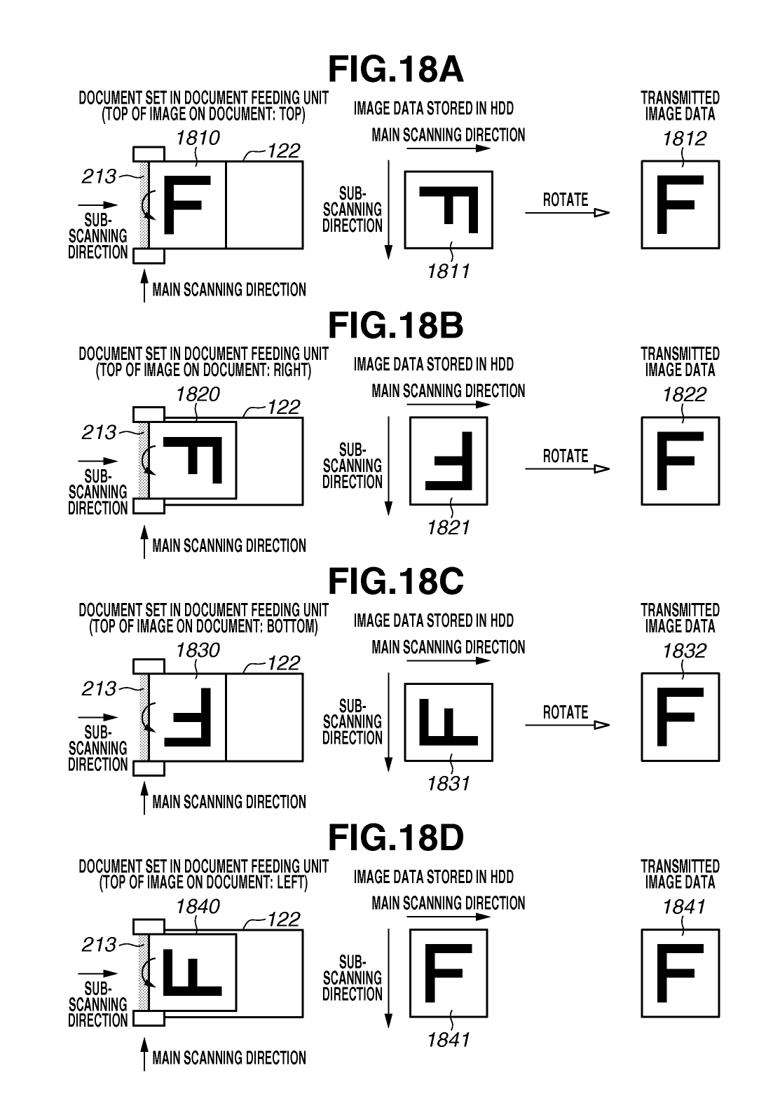

In an MFP 100 according to the third exemplary embodiment, the top of an image on a document will be described with reference to FIG. 18. In the third exemplary embodiment, the top (top, right, bottom, or left) of the image on the document 203 set in the document feeding unit 122 is defined, as illustrated in FIG. 18, when a reader unit 120 reads the image on the document 203 using a direction in which the document 203 is conveyed as a reference. For example, the top of an image 1810 on the document 203 is “top”. For example, the top of an image 1820 on the document 203 is “right”. For example, the top of an image 1830 on the document 203 is “bottom”. For example, the top of an image 1840 on the document 203 is “left”. In the third exemplary embodiment, the fact that the top of an image on a document is “top” is used as a basis.

Then, image data stored in a HDD 160 when the image on the document 203 is read in the MFP 100 according to the third exemplary embodiment will be described below with reference to FIG. 18.

If the document 203 including the image 1810, the top of which is “top”, is set in the document feeding unit 122, and the image 1810 on the document 203 is read, for example, image data 1811 is stored in the HDD 160. If the document 203 including the image 1820, the top of which is “right”, is set in the document feeding unit 122, and the image 1820 on the document 203 is read, for example, image data 1821 is stored in the HDD 160. If the document 203 including the image 1830, the top of which is “bottom”, is set in the document feeding unit 122, and the image 1830 on the document 203 is read, for example, image data 1831 is stored in the HDD 160. If the document 203 including the image 1840, the top of which is “left”, is set in the document feeding unit 122, and the image 1840 on the document 203 is read, for example, image data 1841 is stored in the HDD 160.

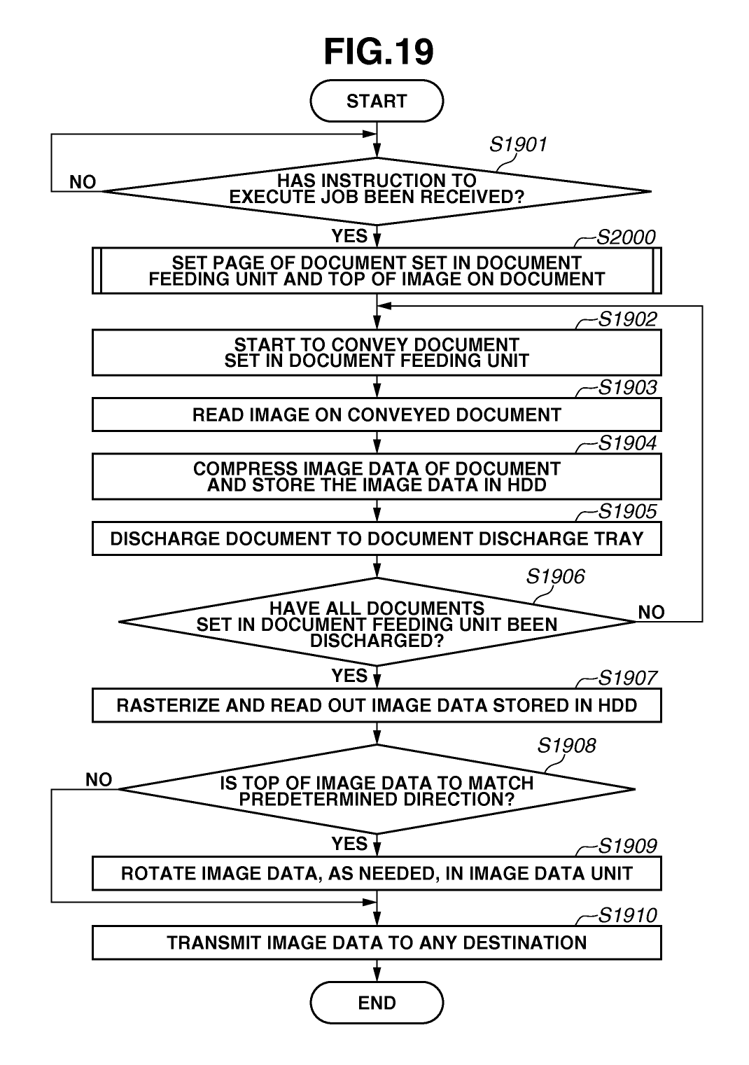

Then, in the MFP 100 according to the third exemplary embodiment, a series of processes for continuously reading images on a plurality of documents set in the document feeding unit 122 and transmitting image data of the read documents will be described with reference to a flowchart illustrated in FIG. 19. Processing illustrated in FIG. 19 is started while a selection button for calling a scan and transmit function 502 is pressed, and a main screen 500 shifts to a screen for executing the scan and transmit function 502. Each of the processes in the flowchart illustrated in FIG. 19 is implemented when a CPU 111 executes a program read from a ROM 115 or the HDD 160 and loaded in a RAM 114. In the third exemplary embodiment, it is assumed that a predetermined direction which the top of the image data is made to match is “top” when image data is transmitted to an external apparatus such as the PC 101.

First, in step S1901, the CPU 111 determines whether an instruction to execute a job has been received by pressing a start key (not illustrated) in an operation unit 150. If the CPU 111 determines that the instruction to execute the job has been received (YES in step S1901), the processing proceeds to step S2000. Otherwise (NO in step S1901), the process in step S1901 is repeated until the CPU 111 determines that the instruction to execute the job has been received.

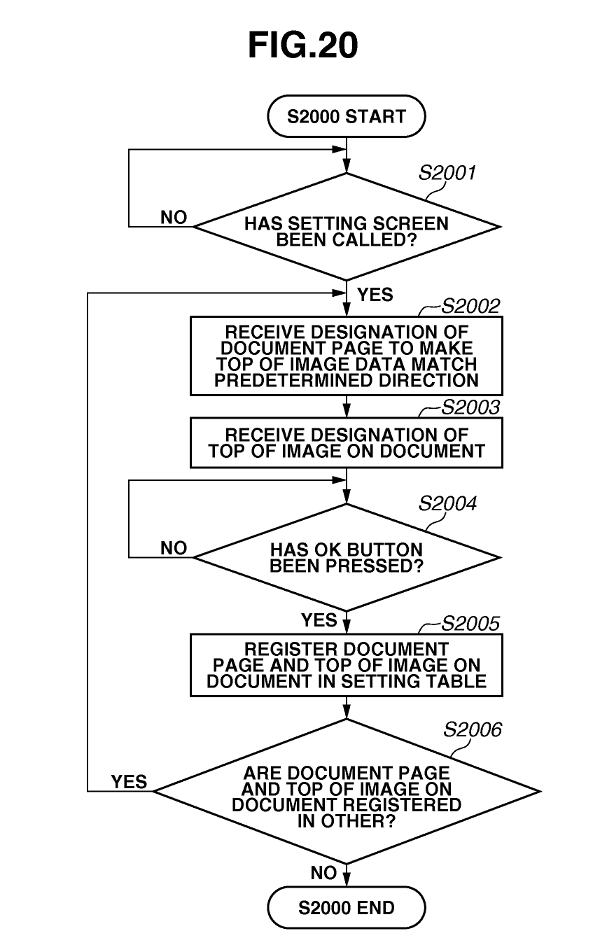

For step S2000 illustrated in FIG. 19 in the third exemplary embodiment, a series of processes for setting a document page corresponding to a document set in the document feeding unit 122 and the top of an image on the document will be described with reference to a flowchart illustrated in FIG. 20. Each of the processes in the flowchart illustrated in FIG. 20 is implemented when the CPU 111 executes a program read from a ROM 115 or the HDD 160 and loaded in a RAM 114.

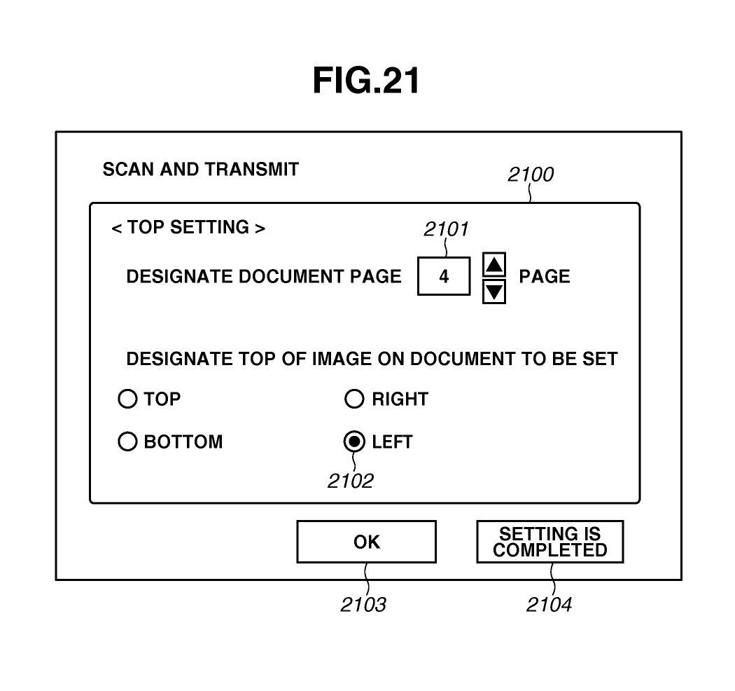

In step S2001, the CPU 111 determines whether a setting screen 2100 illustrated in FIG. 21 for setting a document page corresponding to a document set in the document feeding unit 122 and the top of an image on the document has been called. If the CPU 111 determines that the setting screen 2100 has been called (YES in step S2001), the processing proceeds to step S2002. Otherwise (NO in step S2001), the process in step S2001 is repeated until the CPU 111 determines that the setting screen 2100 has been called.

In step S2002, the CPU 111 receives designation 2101 of a document page corresponding to a document to cause the top of its image data to match a predetermined direction on the setting screen 2100, and the processing proceeds to step S2003.

In step S2003, the CPU 111 receives designation 2102 of the top of an image on a document to be set in the document feeding unit 122 on the setting screen 2100, and the processing proceeds to step S2004. A user designates any one of the top, the right, the bottom, and the left on the setting screen 2100 as the top of the image on the document to be set in the document feeding unit 122.

In step S2004, the CPU 111 determines whether an OK button 2103 has been pressed on the setting screen 2100. If the CPU 111 determines that the OK button 2103 has been pressed (YES in step S2004), the processing proceeds to step S2005. Otherwise (NO in step S2004), the process in step S2004 is repeated until the CPU 111 determines that the OK button 2103 has been pressed.

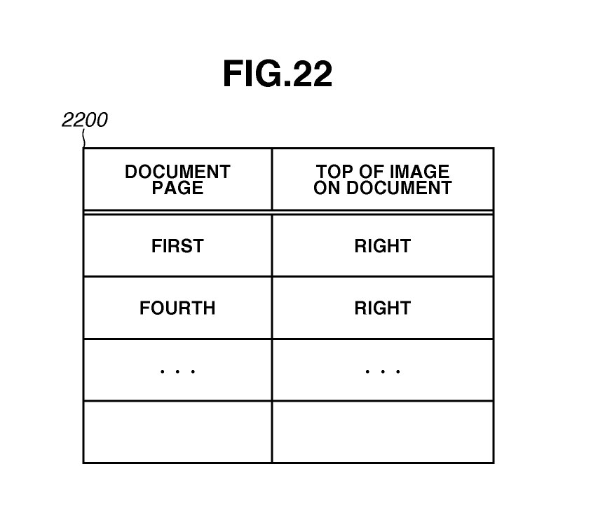

In step S2005, the CPU 111 registers the document page, which has been designated in step S2002, and the top of the image on the document, which has been designated in step S2003, in a setting table 2200 illustrated in FIG. 22, and the processing proceeds to step S2006. Information registered in the setting table 2200 is stored in the RAM 114 or the HDD 160.

In step S2006, the CPU 111 determines whether the document page and the top of the image on the document are registered in others. If the CPU 111 determines that the document page and the top of the image on the document are registered in others (YES in step S2006), the processing returns to step S2002. The CPU 111 performs the process in step S2002 and the subsequent steps. On the other hand, if the CPU 111 determines that the document page and the top of the image on the document are not registered in others (e.g., if a setting completion button 2104 has been pressed) (NO in step S2006), the CPU 111 ends the series of processes (step S2000 illustrated in FIG. 19) for setting the document page and the top of the image on the document, which are set in the document feeding unit 122. Then, the processing proceeds to step S1902 illustrated in FIG. 19.

In step S1902, the CPU 111 issues an instruction to start to convey the document set in the document feeding unit 122, and the processing proceeds to step S1903.

In step S1903, the CPU 111 instructs the reader unit 120 to read an image on the conveyed document, and the processing proceeds to step S1904.

In step S1904, the CPU 111 causes a compression/decompression unit 170 to compress image data of the document, which has been read in step S1903. The CPU 111 compresses the image data, and then stores the compressed image data in the HDD 160, and the processing proceeds to step S1905.

In step S1905, the CPU 111 issues an instruction to discharge the document, which has been conveyed in step S1902, to a document discharge tray, and the processing proceeds to step S1906.

In step S1906, the CPU 111 determines whether all documents set in the document feeding unit 122 have been discharged to the document discharge tray. If the CPU 111 determines that all the documents have not been discharged to the document discharge tray (NO in step S1906), the processing returns to step S1902. The CPU 111 performs the process in step S1902 and the subsequent steps. On the other hand, if the CPU 111 determines that all the documents have been discharged to the document discharge tray (YES in step S1906), the processing proceeds to step S1907.

In step S1907, the CPU 111 causes the compression/decompression unit 170 to decompress and rasterize the compressed image data, which has been stored in the HDD 160 in step S1904. The CPU 111 reads out the rasterized image data, and the processing proceeds to step S1908.

In step S1908, the CPU 111 refers to the document page and the top of the image on the document, which have been registered in the setting table 2200, and determines whether the top of the image data, which has been read out in step S1907, is to match the predetermined direction for each page corresponding to the image data. If the top of the image data is to match the predetermined direction (YES in step S1908), the processing proceeds to step S1909. Otherwise (NO in step S1908), the processing proceeds to step S1910. If a document page corresponding to the document, which has been read in step S1903, has not been subjected to the designation 2101 on the setting screen 2100, the CPU 111 determines that the top of the image data is not to match the predetermined direction (NO in step S1908).

In step S1909, the CPU 111 causes an image rotation unit 180 to rotate the image data, which has been read out in step S1907, as needed, in an image data unit so that the top of the image data faces a predetermined direction, and the processing proceeds to step S1910. In the example illustrated in FIG. 18, if the top of the image on the document 1810 set in the document feeding unit 122 is “top”, the image data 1811 of the document 1810 is rotated, and rotated image data 1812 is transmitted to the PC 101. If the top of the image on the document 1820 set in the document feeding unit 122 is “right”, for example, the image data 1821 of the document 1820 is rotated, and rotated image data 1822 is transmitted to the PC 101. If the top of the image on the document 1830 set in the document feeding unit 122 is “bottom”, for example, the image data 1831 of the document 1830 is rotated, and rotated image data 1832 is transmitted to the PC 101. If the top of the image on the document 1840 set in the document feeding unit 122 is “left”, for example, the image data 1841 of the document 1840 is not rotated, and is transmitted to the PC 101.

In step S1910, the CPU 111 transmits the image data, which has been rotated, as needed, in step S1909, or the image data, which has been read out in step S1907, to any destination via an external I/F 140. The external apparatus such as the PC 101 receives the image data, which has been transmitted in step S1910. A preview screen 1300 illustrated in FIG. 13, described above, is displayed in an operation unit provided in the PC 101. The user can confirm the received image data, the top of which matches “top” without rotating the image data on the preview screen 1300.

The details of the series of processes for continuously reading images on a plurality of documents and transmitting image data of the read documents in the MFP 100 according to the third exemplary embodiment, have been described.

As described above, in the third exemplary embodiment, before images on a plurality of documents are continuously read, the read document is designated in a page unit to make the top of the image data match a predetermined direction while the top of the image on the document is designated. Thus, even if the plurality of documents respectively including the images, which are different in the top, is set in the document feeding unit 122, the image data of the read documents are rotated, as needed, according to the designated tops of the images on the documents so that the tops of the image data can easily be made to match one another.

While the CPU 111 makes the determination described above in step S1908, and rotates the image data, as needed, in step S1909 after compressing the image data of the document, which has been read in step S1903, and storing the compressed image data in the HDD 160 in step S1904, the present invention is not limited to this. The CPU 111 may make the determination described above in step S1908, rotate the image data, as needed, in step S1909, and then compress the image data and store the compressed image data in the HDD 160 before compressing the image data of the document, which has been read in step S1903, and storing the compressed image data in the HDD 160 in step S1904.

While the CPU 111 transmits the image data to any destination via the external I/F 140 in step S1910 after rotating the image data, as needed, in step S1909, the present invention is not limited to this. The CPU 111 may sequentially transmit the image data to any destination via the external I/F 140 while sequentially rotating the image data when transmitting the image data to the destination via the external I/F 140.

While it is assumed that the predetermined direction which the top of the image data is to match is “top” when the image data is transmitted to the external apparatus such as the PC 101, the present invention is not limited to this. Even if the predetermined direction which the top of the image data is to match is “right”, “bottom”, or “left” when the image data is transmitted to the external apparatus such as the PC 101, the third exemplary embodiment to which the present invention is applied can similarly be described.

The present invention is not limited to the above-mentioned exemplary embodiments. Various modifications (including an organic combination of the exemplary embodiments) can be made based on the scope of the present invention, and are not excluded from the scope of the present invention.

For example, a user may be able to set either one of a mode in which image data of a read document is rotated according to a document page designated by the user and a mode in which image data of a read document is rotated according to a document size designated by the user. In such a case, the user can switch whether the image data of the read document is to be rotated according to the mode set by the user according to the designation of the document page or according to the designation of the document size.

If a plurality of documents of different sizes is simultaneously set in the document feeding unit 122, for example, images on the adjacent documents which are different in size may be different in top and bottom directions. For example, in FIG. 17A, images on the third and fourth documents, which are respectively A4 and A3 in size, are different in top and bottom directions. Thus, designation of pages corresponding to all the documents to rotate their image data can be omitted by receiving designation of the head page (the fourth page in the example illustrated in FIG. 17A) of the documents which are different in size from the first-page document.

Similarly, the designation 2101 of the document page corresponding to the document to cause the top of the image data to match the predetermined direction on the setting screen 2100 illustrated in FIG. 21 may be omitted by receiving the designation of the head page of the documents which are different in size from the first-page document.

While the image on the document set in the document tray 202 is read on the document glass 212 in the present exemplary embodiment, the image on the document set in the document platen 221 may be read on a platen glass 220.

While the CPU 111 in the controller unit 110 in the MFP 100 is a main part of the various types of control in the present exemplary embodiment, for example, a printing control apparatus such as an external controller in a separate housing from the MFP 100 may be able to execute some or all of the various types of control.

While the present invention has been described with reference to various examples and exemplary embodiments thereof, it will be apparent to those skilled in this art that the spirit and the scope of the present invention are not limited to the specific description herein above.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-218740 filed Oct. 21, 2013, which is hereby incorporated by reference herein in its entirety.

What is claimed is:

1. An image reading apparatus comprising:
a selection unit configured to select at least one of a plurality of documents;
a reading unit configured to read images on the plurality of documents, to generate image data; and
a rotation control unit configured to perform rotation control so that the top of the image data of the document selected by the selection unit among the image data generated by the reading unit is directed toward a predetermined direction,
wherein the selection unit can select only some of the plurality of documents.

2. The image reading apparatus according to claim 1, wherein the selection unit selects at least one of the plurality of documents by designating a page corresponding to the document.

3. The image reading apparatus according to claim 2, wherein the selection unit selects at least one of the plurality of documents by designating pages corresponding to the documents of different sizes.

4. The image reading apparatus according to claim 1, further comprising a designation unit configured to designate the top of the image on the document selected by the selection unit,
wherein the rotation control unit performs rotation control so that the top of the image data of the document selected by the selection unit is directed toward the predetermined direction according to the top of the image on the document designated by the designation unit.

5. The image reading apparatus according to claim 4, wherein the designation unit designates any one of the top, the right, the bottom, and the left as the top of the image on the document selected by the selection unit.

6. The image reading apparatus according to claim 4, wherein the rotation control unit performs rotation control so that the top of the image data of the document selected by the selection unit is the top according to the top of the image on the document designated by the designation unit.

7. A control method in an image reading apparatus having a reading unit for reading images on a plurality of documents, to generate image data, the control method comprising:
selecting at least one of the plurality of documents; and
performing rotation control so that the top of the image data of the selected document among the image data generated by the reading unit is directed toward a predetermined direction,
wherein only some of the plurality of documents can be selected in the selecting.

8. A computer readable storage medium for storing a computer program for controlling an image reading apparatus, the computer program comprising:
a code to select at least one of a plurality of documents;
a code to read images on the plurality of documents, to generate image data; and
a code to perform rotation control so that the top of the image data of the selected document among the image data generated by the reading is directed toward a predetermined direction,
wherein only some of the plurality of documents can be selected in the selecting.
